(19) United States
(12) Patent Application Publication
(10) Pub. No.: US 2022/0220641 A1
(43) Pub. Date: Jul. 14, 2022

(54) MODELING MATERIAL FOR 3D PRINTERS AND SHAPED ARTICLE

(71) Applicant: LINTEC CORPORATION, Tokyo (JP)

(72) Inventor: Yoshiaki HAGIHARA, Itabashi-ku, Tokyo (JP)

(21) Appl. No.: 17/615,028

(22) PCT Filed: May 26, 2020
(86) PCT No.: PCT/JP2020/020666

§ 371 Date: Nov. 29, 2021

(30) Foreign Application Priority Data
May 30, 2019 (JP) 2019-101478

(51) Int. Cl. D02G 3/04; B33Y 70/10

(52) U.S. Cl. CPC D02G 3/04; B33Y 80/00; B33Y 70/10

(57) ABSTRACT

A 3D-printer modeling material includes for instance, a resin and a wire rod including a carbon nanotube yarn. The resin is a thermoplastic resin.

### TECHNICAL FIELD

The present invention relates to a 3D-printer modeling material and a modeled object.

### BACKGROUND ART

Examples of known three-dimensional modeling techniques include fused deposition modeling, stereolithography, and inkjet printing. Among the above, the fused deposition modeling is a process for thermally melting a filament containing a resin and repeatedly laminating the molten material to form an object. Various studies have been made for the filament used in the fused deposition modeling.

For instance, Patent Literature 1 discloses a 3D printer for deposition-shaping of a part, the 3D printer including a fiber composite filament supply of an unmelted fiber reinforced composite filament and the like. The fiber reinforced composite filament disclosed in Patent Literature 1 includes one or more inelastic axial fiber strands extending within a matrix material of the filament. Patent Literature 1 discloses, as examples of the axial fiber strands, carbon fiber, aramid fiber, and fiberglass.

Patent Literature 2 discloses a filament for a fused-deposition 3D printer. The filament for the fused-deposition 3D printer is made from a functional resin composition containing a thermoplastic matrix resin and a functional nano filler dispersed in the thermoplastic matrix resin.

### CITATION LIST

### Patent Literature(s)

Patent Literature 2: JP 2016-531020 A

Patent Literature 2; JP 2016-28887 A

### SUMMARY OF THE INVENTION

### Problems to be Solved by the Invention

However, modeled objects formed from the modeling material containing the fiber strand (e.g. carbon fiber) disclosed in Patent Literature 1 are, though being excellent in strength, likely to be insufficient in terms of bendability and inferior in flexibility. In contrast, modeled objects formed from the modeling material containing the nano filler disclosed in Patent Literature 2 are likely to be inferior in strength.

Both strength and flexibility are desired for the modeled objects formed by 3D printers.

An object of the invention is to provide a 3D-printer modeling material capable of providing a modeled object exhibiting both strength and flexibility, and a modeled object produced using the 3D-printer modeling material.

### Means for Solving the Problems

According to an aspect of the invention, there is provided a 3D-printer modeling material including; a wire rod including a carbon nanotube yarn; and a resin, in which the resin is a thermoplastic resin.

In the 3D-printer modeling material of the above aspect of the invention, it is preferable that the carbon nanotube yarn is a bundle of a plurality of carbon nanotube yarns or a single carbon nanotube yarn.

In the 3D-printer modeling material of the above aspect of the invention, it is preferable that the carbon nanotube yarn is the bundle of a plurality of carbon nanotube yarns, and

a major diameter of a cross section of the bundle orthogonal to a longitudinal direction of the bundle is in a range from 7 μm to 5000 μm.

In the 3D-printer modeling material of the above aspect of the invention, it is preferable that the carbon nanotube yarn is the single carbon nanotube yarn, and a diameter of the single carbon nanotube yarn is in a range from 5 μm to 100 μm.

In the 3D-printer modeling material of the above aspect of the invention, it is preferable that a content of the wire rod in the 3D-printer modeling material is in a range from 20 mass % to 70 mass %.

In the 3D-printer modeling material of the above aspect of the invention, it is preferable that a content of the resin in the 3D-printer modeling material is in a range from 30 mass % to 80 mass %.

In the 3D-printer modeling material of the above aspect of the invention, it is preferable that the wire rod is twisted.

In the 3D-printer modeling material of the above aspect of the invention, it is preferable that at least a part of an outer circumferential surface of the wire rod is coated with the resin.

In the 3D-printer modeling material of the above aspect of the invention, it is preferable that the resin is a yarn-shaped resin, and the yarn-shaped resin is unidirectionally or multi-directionally and helically wound around an outer circumferential surface of the wire rod.

In the 3D-printer modeling material of the above aspect of the invention, it is preferable that the wire rod further includes a yarn-shaped carbon fiber.

In the 3D-printer modeling material of the above aspect of the invention, it is preferable that a tensile strength of the wire rod is 100 MPa or more.

In the 3D-printer modeling material of the above aspect of the invention, it is preferable that the 3D-printer modeling material is a 3D-printer modeling material for a 3D printer configured to print by fused deposition modeling.

In the 3D-printer modeling material of the above aspect of the invention, it is preferable that the thermoplastic resin is at least one resin selected from the group consisting of a polyolefin resin, polylactic resin, polyester resin, polyvinyl alcohol resin, polyimide resin, acrylonitrile-butadiene-styrene resin, acrylonitrile-styrene resin, acrylate-styrene-acrylonitrile resin, polycarbonate resin, and polyacetal resin.

According to another aspect of the invention, there is provided a modeled object produced using the 3D-printer modeling material according to the above aspect of the invention.

According to still another aspect of the invention, there are provided a 3D-printer modeling material capable of providing a modeled object exhibiting both strength and flexibility, and a modeled object produced using the 3D-printer modeling material.

### BRIEF EXPLANATION OF DRAWINGS

FIG. 1 is a perspective view showing a 3D-printer modeling material according to a first exemplary embodiment.

FIG. 2 is a perspective view showing a 3D-printer modeling material according to a second exemplary embodiment.

FIG. 3 is a perspective view showing a 3D-printer modeling material cording to a third exemplary embodiment.

FIG. 4 is a side elevational view showing a 3D-printer modeling material according to a fourth exemplary embodiment.

FIG. 5 is a side elevational view showing a 3D-printer modeling material according to a fifth exemplary embodiment.

FIG. 6 illustrates an outline of a fused deposition modeling 3D printer used for producing a modeled object according to a sixth exemplary embodiment.

FIG. 7 shows an outline of a cartridge installed in the fused deposition modeling 3D printer shown in FIG. 6.

### DESCRIPTION OF EMBODIMENT(S)

The 3D-printer modeling material will be sometimes referred to as a “modeling material” hereinafter. Further, the carbon nanotube and the carbon nanotube yarn will be sometimes abbreviated hereinafter as “CNT” and “CNT yarn,” respectively.

The modeling material herein is typically used in a fused deposition modeling 3D printer. The shape of the modeling material, which is not specifically limited as long as usable in a 3D printer, is typically string-shaped. The string-shaped modeling material is wound around a core (e.g. bobbin) in use.

### First Exemplary Embodiment

A first exemplary embodiment of the invention will be described below with reference to the attached drawings.

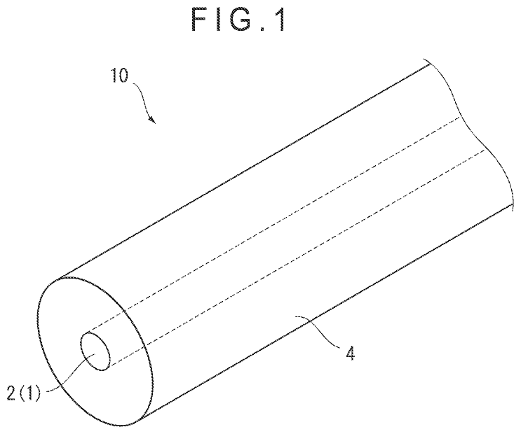

FIG. 1 is a perspective view showing a modeling material 10 according to the first exemplary embodiment.

The modeling material 10 according to the present exemplary embodiment includes a wire rod 2 in a form of a single CNT yarn 1 and a resin 4. The resin 4 is a thermoplastic resin. The wire rod 2 is disposed in a longitudinal direction of the modeling material 10, an outer circumferential surface of the wire rod 2 being coated with the resin 4. In the first exemplary embodiment, the wire rod 2 is made of the single CNT yarn 1 as shown in FIG. 1.

The modeling material 10 according to the present exemplary embodiment includes the resin 4 and the wire rod 2 including the CNT yarn 1. Using the modeling material 10 according to the present exemplary embodiment in a 3D printer results in modeled objects exhibiting both strength and flexibility. The reasons thereof are considered as follows.

A modeling material containing a carbon fiber in a resin has been known as disclosed in Patent Literature 1. The modeled object made from the modeling material containing the carbon fiber exhibits excellent strength in the longitudinal direction of the carbon fiber, but tends to be low in strength in a diameter direction of the carbon fiber (i.e. in the thickness direction of the modeled object). Further, the modeled object containing the carbon fiber is likely to be insufficient in bendability and inferior in flexibility.

In contrast, the modeled object provided by the modeling material 10 according to the present exemplary embodiment contains the CNT yarn 1, which is more flexible than the carbon fiber and has suitable strength. Accordingly, it is believed that the modeled object provided by the modeling material 10 according to the present exemplary embodiment can keep a good balance between the strengths in the longitudinal direction and in the diameter direction (i.e. the thickness direction of the modeled object) of the CNT yarn 1, enhancing the strength of the entirety of the modeled object. Further, the modeled object provided by the modeling material 10 according to the present exemplary embodiment, which contains the CNT yarn 1, is excellent in flexibility as compared with the modeled object containing the carbon fiber.

Meanwhile, some known modeling materials contain the CNT dispersed in a resin as disclosed in Patent Literature 2. The modeled object provided by such a modeling material has strength substantially equal to the strength of the resin, and thus is likely to inferior in the strength to the modeled object containing the CNT yarn. It is possible to increase the amount of CNT in the resin to enhance the strength. However, such increase in the amount of CNT disadvantageously leads to decrease in compatibility between the resin and CNT.

As described above, modeled objects exhibiting both strength and flexibility can be produced with the use of the modeling material 10 according to the present exemplary embodiment. The modeling material that contains the CNT in a form of a “yarn” in the resin as in the present exemplary embodiment is not known in the related art.

The modeling material 10 according to the present exemplary embodiment is suitably usable in a 3D printer configured to print by the fused deposition modeling.

It should be noted that the “strength” herein means a mechanical strength. The strength can be determined by, for instance, measuring a tensile strength [MPa] of the wire rod. Further, the flexibility herein can be determined by, for instance, performing a bending test on the wire rod.

How the tensile strength of the wire rod is measured and how the bending test is performed will be described later under the section of Examples.

Next, the details of the modeling material 10 according to the present exemplary embodiment will be described below.

In the description below, the term “CNT yarn” means “a single CNT yarn” unless otherwise specified, and the term “bundle” or “bundle of the CNT yarn” means a “bundle of a plurality of CNT yarns.” unless otherwise specified.

### Wire Rod

In the present exemplary embodiment, the wire rod 2 contains the single CNT yarn 1. The content of the CNT yarn 1 in the wire rod 2 is preferably 70 mass % or more, more preferably 90 mass % or more, further preferably 95 mass % or more.

When the content of the CNT yarn 1 in the wire rod 2 is 70 mass % or more, the modeling material and the modeled object exhibiting both strength and flexibility are easily produced.

The diameter of the single CNT yarn 1 is preferably in a range from 5 μm to 100 μm, more preferably from 7 μm to 75 μm, further preferably from 10 μm to 50 μm.

The CNT yarn 1 whose diameter is 5 μm or more easily enhances the strength of the wire rod 2.

The CNT yarn 1 whose diameter is 100 μm or less easily improves the flexibility of the wire rod 2.

It should be noted that, when the cross section of the CNT yarn 1 is not circular (e.g. ellipsoidal), the diameter of the CNT yarn 1 is defined by the largest width of the cross section.

When the wire rod 2 is provided by the single CNT yarn 1, the diameter of the wire rod 2 is the same as the diameter of the single CNT yarn.

### Manufacturing Method of CNT Yarn

The CNT yarn is produced by, for instance, drawing a sheet of CNT from an end of a CNT forest (i.e. a grown body of a plurality of CNT grown in a manner vertically oriented with respect to a substrate, sometimes referred to as an “array”), bundling the drawn CNT sheet, and then twisting the bundle of the CNT, as necessary. It should be noted that the diameter of the CNT yarn can be adjusted by changing the width of the CNT sheet drawn from the CNT forest.

Alternatively, the CNT yarn can also be produced from a dispersion liquid of CNT through a spinning process or the like. The production of the CNT yarn by the spinning process is performed by, for instance, a method disclosed in US 2013/0251619 A (WO 2012/070537 A).

At least a part of the outer circumferential surface of the wire rod 2 is preferably coated with the resin 4. With the above arrangement, when the modeling material 10 is melted to be deposited, the resin 4 easily permeates into the wire rod 2, allowing the resin in neighboring pieces of the modeling material to be readily bonded.

In order to enhance the resin bondability, the wire rod 2 is more preferably coated with the resin 4 over the entirety of the outer circumferential surface thereof, as shown in FIG. 1.

The content of the wire rod 2 in the modeling material 10 is preferably in a range from 20 mass % to 70 mass %, more preferably from 25 mass % to 65 mass %, further preferably from 30 mass % to 60 mass %.

With a content of the wire rod 2 of 20 mass % or more, the modeled object exhibiting both strength and flexibility is easily produced.

A predetermined ratio of the resin 4 to the modeling material 10 can be ensured at a content of the wire rod 2 of 70 mass % or less, allowing the resin in neighboring pieces of the modeling material to be easily bonded when the modeling material is melted to be deposited.

### Tensile Strength

The tensile strength of the wire rod 2 is measurable using a tension/compression testing machine (RTG-1225, manufactured by A&D Company, Limited).

The tensile strength of the wire rod 2 is preferably 100 MPa or more, more preferably 500 MPa or more. The upper limit, which is not specifically limited, is preferably 20000 MPa or less in terms of applicability to a manufacturing process. With a tensile strength of the wire rod 2 of 100 MPa or more, the modeled object exhibiting excellent strength is easily produced. Details of the measurement method will be described in the section of Examples.

### Resin

The resin 4 is a thermoplastic resin.

The thermoplastic resin is preferably at least one resin selected from the group consisting of a polyolefin resin, polylactic resin, polyester resin, polyvinyl alcohol resin, polyamide resin, acrylonitrile-butadiene-styrene resin, acrylonitrile-styrene resin, acrylate-styrene-acrylonitrile resin, polycarbonate resin, and polyacetal resin.

Examples of the polyolefin resin include polyethylene resin, polypropylene resin, ethylene-(α-olefin) copolymer resin, propylene-(α-olefin) copolymer resin, and cyclic polyolefin resin.

Examples of the polylactic resin include poly L-lactic acid and poly D-lactic acid.

Examples of the polyester resin include polyethylene terephthalate resin, polybutylene terephthalate resin, cyclohexanedimethanol copolymer polyethylene terephthalate resin, polyethylene naphthalate resin, and polybutylene naphthalate resin.

Examples of the polyamide resin include nylon 6,6, nylon 12, and modified polyamide.

One of the above thermoplastic resins may be used alone, or two or more of the above may be used in combination.

In the present exemplary embodiment, the content of the resin 4 in the modeling material 10 is preferably in a range from 30 mass % to 80 mass %, more preferably from 35 mass % to 75 mass %, further preferably from 40 mass % to 70 mass %.

With a content of the resin 4 of 30 mass % or more, the resin in neighboring pieces of the modeling material is easily bonded when the modeling material 10 is melted to be deposited.

With a content of the resin 4 of 80 mass % or less, a predetermined ratio of the wire rod 2 to the modeling material 10 is secured, easily resulting in a modeled object exhibiting both strength and flexibility.

In the present exemplary embodiment, the volume ratio (wire rod/resin) of the wire rod 2 to the resin 4 in the modeling material 10 is preferably in a range from 10/90 to 80/20, more preferably in a range from 30/70 to 70/30.

With a volume ratio (wire rod/resin) of the wire rod 2 to the resin 4 in the modeling material 10 in a range from 10/90 to 80/20, a modeled object exhibiting a good balance between strength and flexibility is easily produced.

In the present exemplary embodiment, a major diameter of a cross section orthogonal to a longitudinal direction of the modeling material 10 is preferably in a range from 6 μm to 200 μm, more preferably from 10 μm to 150 μm, further preferably from 20 μm to 100 μm.

The term “major diameter of a cross section” is defined as follows: a maximum length of a segment defined by the cross section when a straight line intersecting the cross section is drawn. The same definition of the “major diameter of a cross section” applies hereinafter.

When the major diameter of the cross section orthogonal to the longitudinal direction of the modeling material 10 is 6 μm or more, handleability is enhanced.

When the major diameter of the cross section orthogonal to the longitudinal direction of the modeling material 10 is 200 μm or less, a predetermined ratio of the wire rod 2 to the modeling material 10 is secured, easily resulting in a modeled object exhibiting both strength and flexibility.

The modeling material 10 may contain any other additional component(s) than the CNT yarn 1 and the resin 4.

Examples of the additional component(s) include an additive, an organic filler, an inorganic filler, a resin other than the thermoplastic resin, and a reinforcing fiber (e.g. a carbon fiber, glass fiber, and Kevlar fiber). Examples of the additive include an antioxidant, UV absorber, flame retardant, plasticizer, softening agent, surface modifier, thermal stabilizer, and coloring agent.

The content of the additional component(s) other than the CNT yarn 1 and the resin 4 in the modeling material 10, if present, is preferably 30 mass % or less, more preferably less than 10 mass %, further preferably 5 mass % or less with respect to the entirety of the modeling material 10.

### Manufacturing Method of Modeling Material in the First Exemplary Embodiment

When the wire rod 2 is provided by, for instance, a single CNT yarn 1, the modeling material is manufactured as follows.

Initially, the single CNT yarn 1 is prepared. The CNT yarn 1 may be manufactured by the above-described method or be a commercially available product.

Subsequently, the resin is applied on (preferably an entirety of) the outer circumferential surface of the CNT yarn 1. A method of coating the outer circumferential surface of the CNT yarn 1 with the resin is not particularly limited, and is exemplified, for instance, by a method of applying/dropping a solution containing the resin on the outer circumferential surface of the CNT yarn 1, or a method of immersing the CNT yarn 1 in the solution containing the resin.

Alternatively, the outer circumferential surface of the CNT yarn 1 may be coated with the resin by a method of extruding the resin on the outer circumferential surface of the CNT yarn 1 to form a layer of the resin or a method of winding a sheet-shaped resin molding on the outer circumferential surface of the CNT yarn 1 and melting the resin molding. Examples of an extruder usable in the extruding/layer-forming process include a uniaxial extruder and a biaxial extruder.

Further alternatively, the outer circumferential surface of the CNT yarn 1 may be coated with the resin by a known means for coating electric wires (e.g. a wire coating apparatus).

Still alternatively, the resin may be sprayed onto the CNT by dropping a solution containing the resin onto the CNT in any one of the steps of drawing the sheet-shaped CNT from an end of the CNT forest, bundling the drawn CNT sheet, and twisting the bundled CNT of the above-described “Manufacturing Method of CNT yarn 1.” The outer circumferential surface of the CNT yarn 1 can also be coated with the resin through the above process.

It should be noted that, in view of compatibility of the CNT yarn with the resin, it is preferable to perform the “method of coating the outer circumferential surface of the CNT yarn 1 with the resin” after coating the CNT yarn in advance with a resin highly compatible with the CNT yarn.

### Second Exemplary Embodiment

A second exemplary embodiment of the invention will be described below, where difference(s) from the first exemplary embodiment will be focused and the same or similar components/features will not be described.

A modeling material 10A according to the second exemplary embodiment is the same as the modeling material 10 according to the first exemplary embodiment except for the use of a wire rod 20 in place of the wire rod 2.

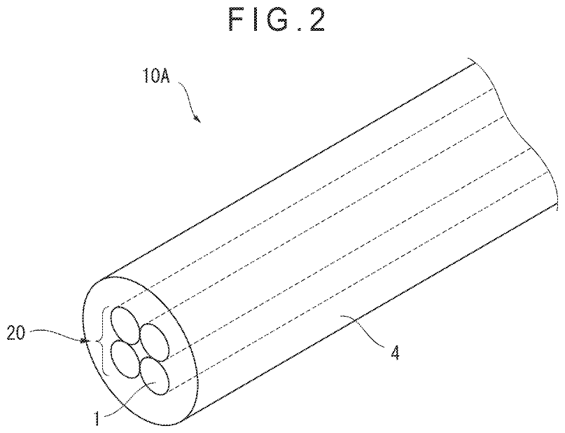

FIG. 2 is a perspective view showing the modeling material 10A according to the second exemplary embodiment.

The modeling material 10A includes the wire rod 20 including a bundle of the CNT yarns and the resin 4. In the second exemplary embodiment, the wire rod 20 is in a form of a bundle of four CNT yarns 1. FIG. 2 shows the bundle of the four CNT yarns arranged substantially in parallel along a longitudinal direction of the modeling material 10A.

The wire rod 20, which includes the bundle of the four CNT yarns 1 in the second exemplary embodiment, may include unlimited number of (as long as being two or more) CNT yarns 1. It should however be noted that the number of the CNT yarns is preferably determined so that a predetermined (preferably 100 MPa or more) tensile strength of the wire rod 20 can be ensured.

The plurality of CNT yarns in the wire rod 20 may have the same diameter or mutually different diameters.

The major diameter of the cross section orthogonal to the longitudinal direction of the bundle of the CNT yarns (the bundle of the four CNT yarns in the present exemplary embodiment) is preferably in a range from 7 μm to 5000 μm; more preferably from 20 μm to 3000 μm, further preferably from 50 μm to 1000 μm.

With a major diameter of the cross section orthogonal to the longitudinal direction of the bundle being 7 μm or more, the strength of the wire rod 20 is easily enhanced.

With a major diameter of the cross section orthogonal to the longitudinal direction of the bundle being 5000 μm or less, the flexibility of the wire rod 20 is easily enhanced.

It should be noted that the major diameter of the bundle of the CNT yarns refers to a maximum distance between selected two points on a contour of the cross section in a direction orthogonal to the longitudinal direction of the bundle.

In the second exemplary embodiment, the major diameter of the cross section orthogonal to the longitudinal direction of the modeling material 10A is preferably in a range from 10 μm to 5100 μm, more preferably from 25 μm to 3100 μm, further preferably from 55 μm to 1100 μm.

When the major diameter of the cross section orthogonal to the longitudinal direction of the modeling material 10A is 10 μm or more, handleability is enhanced.

When the major diameter of the cross section orthogonal to the longitudinal direction of the modeling material 10A is 5100 μm or less; a predetermined ratio of the wire rod 20 to the modeling material 10A is secured; easily resulting in a modeled object exhibiting both strength and flexibility.

In the second exemplary embodiment, the content of the bundle of the CNT yarns with respect to the entirety of the wire rod 20, the content of the wire rod 20 with respect to the entirety of the modeling material 10A, the tensile strength of the wire rod 20, the content of the resin 4 with respect to the entirety of the modeling material 10A, and the volume ratio (wire rod/resin) of the wire rod 20 to the resin 4 in the modeling material 10A are in the same range and the same preferable ranges as those defined for the content of the CNT yarn 1 with respect to the entirety of the wire rod 2, the content of the wire rod 2 with respect to the entirety of the modeling material 10, the tensile strength of the wire rod 2, the content of the resin 4 with respect to the entirety of the modeling material 10, and the volume ratio (wire rod/resin) of the wire rod 2 to the resin 4 in the modeling material 10 in the first exemplary embodiment, respectively.

The same applies to later-described third to fifth exemplary embodiments.

With the use of the modeling material 10A according to the second exemplary embodiment, a modeled object exhibiting both strength and flexibility can be provided. Further, the modeling material 10A according to the second exemplary embodiment, which includes the wire rod 20 in a form of the bundle of the CNT yarns, can easily adjust its diameter in accordance with a nozzle diameter of a 3D printer.

### Manufacturing Method of Modeling Material in the Second Exemplary Embodiment

The modeling material 10A shown in FIG. 2 is manufactured, for instance, as follows.

Initially, four CNT yarns 1 are prepared and are bundled to provide a bundle of the CNT yarns 1. Subsequently, the outer circumferential surface of the bundle is coated with the resin by the “method of coating the outer circumferential surface of the CNT yarn 1 with the resin” described in the manufacturing method of the modeling material of the first exemplary embodiment.

### Third Exemplary Embodiment

A third exemplary embodiment of the invention will be described below, where difference(s) from the second exemplary embodiment will be focused and the same or similar components/features will not be described.

A modeling material 10B according to the third exemplary embodiment is the same as the modeling material 10A according to the second exemplary embodiment except for the use of a wire rod 20A in place of the wire rod 20.

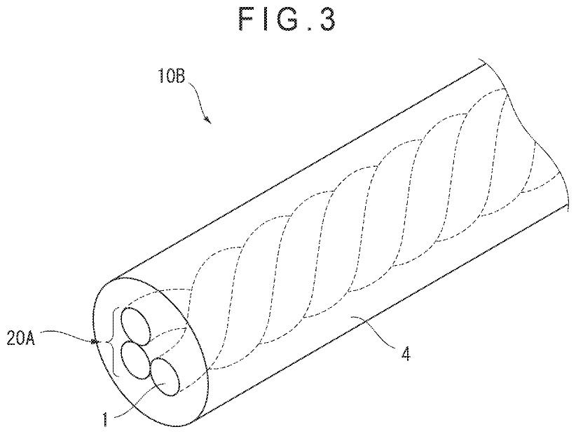

FIG. 3 is a perspective view showing a modeling material 10B according to the third exemplary embodiment.

The modeling material 10B includes the resin 4 and the wire rod 20A including a bundle of a plurality of CNT yarns. In the third exemplary embodiment, the wire rod 20A is in a form of the bundle of mutually twisted three CNT yarns 1. FIG. 3 shows the bundle (twisted yarns) of three CNT yarns arranged along a longitudinal direction of the modeling material 10B. It should be noted that the CNT yarns are not necessarily twisted as shown in FIG. 3.

The plurality of CNT yarns in the wire rod 20A may have the same diameter or mutually different diameters.

In the third exemplary embodiment, the major diameter of the cross section orthogonal to the longitudinal direction of the bundle of the mutually twisted three CNT yarns 1 (wire rod 20A) is in the same range and the same preferable ranges as defined for the major diameter of the cross section in the second exemplary embodiment.

The modeling material 10B according to the third exemplary embodiment can provide a modeled object exhibiting both strength and flexibility. Further, the modeling material 10B according to the third exemplary embodiment, which includes the wire rod 20A in a form of the bundle (twisted yarns) of the three mutually twisted CNT yarns 1, can easily adjust its diameter in accordance with a nozzle diameter of a 3D printer.

### Manufacturing Method of Modeling Material in the Third Exemplary Embodiment

The modeling material 10B shown in FIG. 3 is manufactured, for instance, as follows.

Initially, three CNT yarns 1 are prepared and are bundled to provide a bundle of the CNT yarns 1. Subsequently, the three CNT yarns are mutually twisted. Next, the outer circumferential surface of the bundle (twisted yarns) is coated with the resin by the “method of coating the outer circumferential surface of the CNT yarn 1 with the resin” described in the manufacturing method of the modeling material of the first exemplary embodiment.

### Fourth Exemplary Embodiment

A fourth exemplary embodiment of the invention will be described below, where difference(s) from the second exemplary embodiment will be focused and the same or similar components/features will not be described.

The modeling material of the fourth exemplary embodiment is the same as the modeling material 10A according to the second exemplary embodiment except that the resin is a yarn-shaped resin.

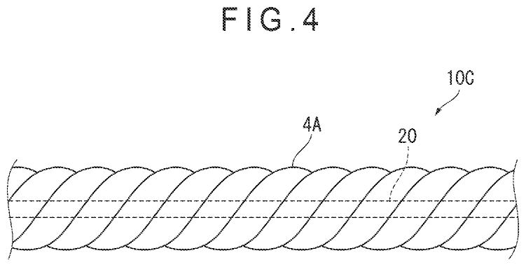

FIG. 4 is a side elevational view showing a modeling material 10C according to the fourth exemplary embodiment.

The modeling material 10C includes the wire rod 20 of the second exemplary embodiment and a yarn-shaped resin 4A. In the fourth exemplary embodiment, the yarn-shaped resin 4A is unidirectionally and helically wound along the outer circumferential surface of the wire rod 20. Specifically, the entirety of the outer circumferential surface of the wire rod 20 is coated with the yarn-shaped resin 4A.

In the fourth exemplary embodiment; the number of turns, helical angle, and helical direction of the yarn-shaped resin 4A on the wire rod 20 are not specifically limited. Although the entirety of the outer circumferential surface of the wire rod 20 is preferably coated with the yarn-shaped resin 4A as shown in FIG. 4, the outer circumferential surface of the wire rod 20 may be partially coated with the yarn-shaped resin 4A.

In the fourth exemplary embodiment, the major diameter of the cross section orthogonal to the longitudinal direction of the bundle of the CNT yarns is in the same range and the same preferable ranges as defined for the major diameter of the cross section in the second exemplary embodiment.

The modeling material 10C according to the fourth exemplary embodiment can provide a modeled object exhibiting both strength and flexibility. The modeling material 10C according to the fourth exemplary embodiment, in which the outer circumferential surface of the wire rod 20 is coated with the yarn-shaped resin 4A, can easily adjust its diameter in accordance with a nozzle diameter of a 3D printer.

### Manufacturing Method of Modeling Material in the Fourth Exemplary Embodiment

The modeling material 10C shown in FIG. 4 is manufactured, for instance, as follows.

Initially, the wire rod 20 of the second exemplary embodiment is prepared. Subsequently, according to a known method, the yarn-shaped resin 4A is unidirectionally and helically wound around the outer circumferential surface of the wire rod 20 to produce the modeling material 10C. It should be noted that an adhesive or the like may be used as necessary when the resin 4A is wound around the wire rod 20. The modeling material 10C may be thermally treated after the yarn-shaped resin 4A is wound around the wire rod 20.

### Fifth Exemplary Embodiment

A fifth exemplary embodiment of the invention will be described below, where difference(s) from the first exemplary embodiment will be focused and the same or similar components/features will not be described.

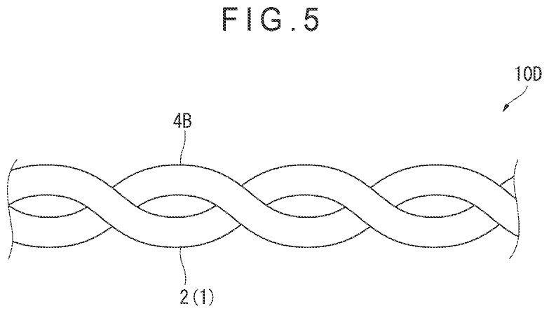

FIG. 5 is a side elevational view showing a modeling material 10D according to the fifth exemplary embodiment.

The modeling material 10D of the fifth exemplary embodiment includes the wire rod 2 including the single CNT yarn 1 used in the first exemplary embodiment and a single yarn-shaped resin 4B, the wire rod 2 and the resin 4B being mutually twisted. It should be noted that the number of the wire rods 2 and the number of the resins 4B are not specifically limited.

The modeling material 10D of the fifth exemplary embodiment can provide a modeled object exhibiting both strength and flexibility. Further, the modeling material 10D according to the fifth exemplary embodiment, in which the wire rod 2 and the yarn-shaped resin 4B are twisted, can easily adjust its diameter in accordance with a nozzle diameter of a 3D printer.

### Manufacturing Method of Modeling Material in the Fifth Exemplary Embodiment

The modeling material 10D shown in FIG. 5 is manufactured, for instance, as follows.

Initially, the wire rod 2 of the first exemplary embodiment and the yarn-shaped resin 48 are prepared. Then, the wire rod 2 and the yarn-shaped resin 48 are mutually twisted.

### Sixth Exemplary Embodiment

A modeled object according to the present exemplary embodiment is produced by using any one of the modeling materials according to any one of the above-described exemplary embodiments.

The modeled object of the present exemplary embodiment thus exhibits both strength and flexibility.

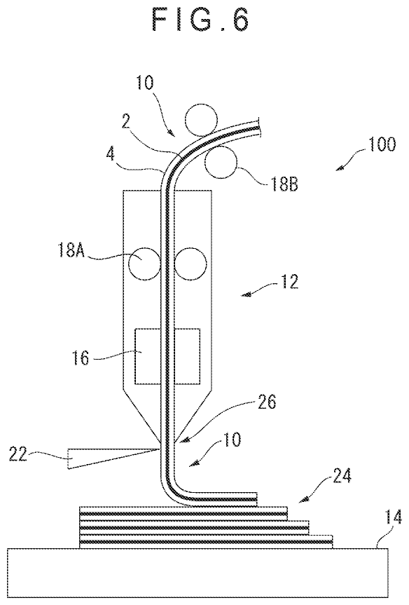

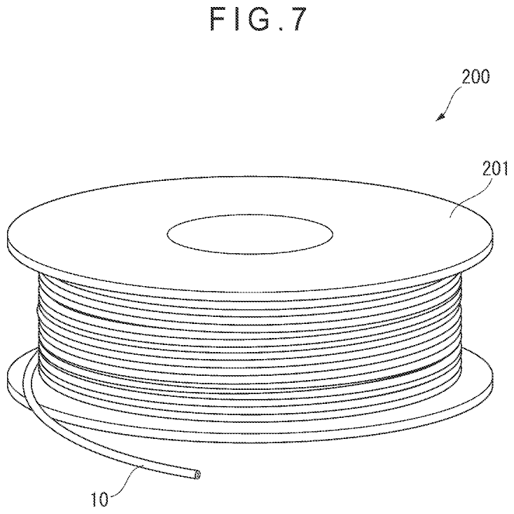

A manufacturing method of the modeled object of the present exemplary embodiment will be described below with reference to FIGS. 6 and 7.

In the present exemplary embodiment, an instance for manufacturing the modeled object with the use of the modeling material 10 of the first exemplary embodiment will be described below.

FIG. 6 shows an outline of a fused deposition modeling 3D printer 100.

FIG. 7 shows an outline of a cartridge 200 installed in the 3D printer 100 shown in FIG. 6.

The 3D printer 100 includes a base 14 on which the modeling material 10 in a form of a molten material is deposited, an extruder head 12, a pair of conveying rollers 18A, 188 configured to convey the modeling material 10, and a cartridge receiver (not shown).

The extruder head 12 includes a nozzle 26 configured to melt and extrude the resin in the modeling material 10 and a heater 16 installed in the extruder head 12 and configured to heat the modeling material 10 at an upstream of the nozzle 26. Further, a cutter 22, which is configured to cut the modeling material 10 as necessary while the modeling material 10 is deposited, is provided in or near an opening of the nozzle 26.

The cartridge 200 is installed in the cartridge receiver (not shown). As shown in FIG. 7, the cartridge 200 includes a bobbin 201 (core) and the modeling material 10 wound around the bobbin 201.

Although the shape and size of the bobbin (core) are not specifically limited, a bobbin suitable for the length of the modeling material and the shape of the 3D printer is preferably selected as appropriate. Further, although FIG. 7 shows one cartridge, the number of the cartridges is not necessarily one and may be two or more.

The modeled object is produced as follows.

The modeling material 10 is conveyed by a conveying roller 18B from the cartridge 200 installed in the cartridge receiver (not shown) to the extruder head 12, passes through an inside of the extruder head, and is conveyed to the nozzle 26 by a conveying roller 18A.

The modeling material 10 in the extruder head 12 is heated by the heater 16 to be extruded from the nozzle 26 after being transformed into the molten material. The molten material extruded from the nozzle 26 is deposited on the base 14. When the first layer of the molten material is deposited on the base 14, the modeling material 10 is cut by the cutter 22 as necessary. The second, third, and subsequent layers of the molten material are sequentially deposited through the repetition of this process. The molten material 24 formed of the plurality of layers deposited on the base 14 is cooled by air-cooling or the like to be solidified. The modeled object is thus produced.

### Modification(s) of Exemplary Embodiment

The invention is not limited to the above-described exemplary embodiments but includes modifications, improvements and the like as long as such modifications, improvements, and the like are compatible with the invention.

The wire rod in each of the exemplary embodiments related to the modeling material may contain any other fiber than the CNT yarn as long as the flexibility of the modeling material is not impaired. Examples of any other fiber include carbon fiber, aramid fiber, and glass fiber. The fiber, whose shape is not specifically limited, is preferably yarn-shaped.

Among the above, the wire rod preferably contains, in addition to the CNT yarn, a yarn-shaped carbon fiber in order to enhance the strength while maintaining the flexibility. In this case, the CNT yarn and the yarn-shaped carbon fiber may be mutually twisted to form a twisted yarn, be bundled substantially in parallel to form a bundle of yarns, or be in a form of a multiple wound yarn. The number of the yarn-shaped carbon fibers is preferably selected within a range without impairing the flexibility of the wire rod.

For instance, the modeling material of the first exemplary embodiment may include two or more wire rods, as in the second exemplary embodiment. In this case, the two or more wire rods included in the modeling material may be mutually spaced apart in a radial direction.

For instance, the plurality of CNT yarns included in the wire rod in the second exemplary embodiment are alternatively and optionally in a form of twisted yarns, multiple wound yarns, or a braid.

For instance, the plurality of CNT yarns included in the wire rod in the third exemplary embodiment are each alternatively and optionally a non-twisted bundle of yarns, multiple wound yarn, or braid.

For instance, the yarn-shaped resin, which is unidirectionally and helically wound around the outer circumferential surface of the wire rod in the fourth exemplary embodiment, may be multi-directionally helically wound around the outer circumferential surface of the wire rod. Examples of the structure of the multi-directionally helically wound yarn-shaped resin include a braid structure.

For instance, the modeling material of the fifth exemplary embodiment may be a braid formed from the wire rod, the yarn-shaped resin, and optional other fiber(s).

In the above-described exemplary embodiments related to the modeling material, the number of the CNT yarns in the wire rod, whether and how the CNT yarns are twisted, the number and angle of twisting, and the number, angle, and direction of helixes are selectable as desired.

### EXAMPLES

The invention will be more specifically described below with reference to Examples. It should however be noted that these Examples by no means limit the scope of the invention.

### Example 1

A multiwall CNT forest formed on a silicon wafer was prepared. A ribbon-shaped CNT was drawn from a side surface of the CNT forest and was twisted to form a wire rod in a form of a single CNT yarn. The CNT yarn had a major diameter of 26.4 μm.

### Example 2

A multiwall CNT forest formed on a silicon wafer was prepared. A ribbon-shaped CNT was drawn from a side surface of the CNT forest and was twisted to form a single CNT yarn. Sixteen pieces of the CNT yarns were twisted to form a wire rod in a form of a bundle of the CNT yarns. The major diameter of the bundle (twisted yarns) of the sixteen CNT yarns was 112.3 μm.

Comparative 1

Yarn-shaped carbon fibers (manufactured by Toray Industries, Inc.: diameter 7 μm×1000 pcs.) were prepared.

Then, the fiber was torn into approximately 30-μm-diameter pieces to form a wire rod of Comparative 1. The counted number of the torn pieces of the carbon fiber was 24.

### Evaluation

The wire rods of Examples 1 to 2 and Comparative 1 were cut into 4 cm pieces using a cutter. Then, 1.5-cm length of end parts of each of the wire rods were fixed on a base paper using an adhesive (Aron Alpha EXTRA4020, manufactured by Toagosei Co., Ltd.) to prepare a test piece whose measurement length was 1 cm. The test piece was used to perform a tensile test and a bending test. The results are shown in Table 1.

### Tensile Test

The tensile strength of each test piece when the wire rod was torn apart was measured under the following conditions. Evaluation standards are shown below.

Conditions

Tension/compression testing machine (RTG-1225, manufactured by A$D Company, Limited)

Tensile rate . . . 1 mm/min

Measurement environment . . . 23 degrees C., 50% RH

Standards

A . . . 500 MPa or more

B . . . 100 MPa or more and less than 500 MPa

C . . . less than 100 MPa

### Bending Test

While the both ends of the wire rod of each test piece fixed on the base paper were held by hands, the wire rod was bent by 90 degrees to evaluate the condition of the test piece. Evaluation standards are shown below.

Standards

A . . . Not torn

B . . . Partially torn

C . . . Completely torn

TABLE 1

| | Example 1 | Example 2 | Comparative 1 |
|---|---|---|---|
| Tensile Test | A | A | A |
| Bending Test | A | A | C |

The wire rods of Examples 1 and 2 were excellent in tensile strength. Further, the wire rods of Examples 1 and 2 were excellent in flexibility as compared with the wire rod of Comparative 1 as demonstrated by the results of the bending test.

Accordingly, a modeled object exhibiting both strength and flexibility can be produced by preparing a modeling material using the wire rod in Example 1 or 2 and thermoplastic resin and using the prepared modeling material in a fused deposition modeling 3D printer.

### EXPLANATION OF CODES

1 . . . CNT yarn, 2, 20, 20A . . . wire rod, 4, 4A, 4B . . . resin, 10, 10A, 10B, 10C, 10D . . . modeling material, 12 . . . extruder head, 14 . . . base, 16 . . . heater, 18A, 18B . . . a pair of conveying rollers, 22 . . . cutter, 24 . . . molten material, 26 . . . nozzle, 100 . . . 3D printer, 200 . . . cartridge, 201 . . . bobbin

1. A 3D-printer modeling material comprising:
a wire rod comprising a carbon nanotube yarn; and
a resin, wherein
the resin is a thermoplastic resin.

2. The 3D-printer modeling material according to claim 1, wherein the carbon nanotube yarn is a bundle of a plurality of carbon nanotube yarns or a single carbon nanotube yarn.

3. The 3D-printer modeling material according to claim 2, wherein
the carbon nanotube yarn is the bundle of the plurality of carbon nanotube yarns, and
a major diameter of a cross section of the bundle orthogonal to a longitudinal direction of the bundle is in a range from 7 μm to 5000 μm.

4. The 3D-printer modeling material according to claim 2, wherein
the carbon nanotube yarn is the single carbon nanotube yarn, and
a diameter of the single carbon nanotube yarn is in a range from 5 μm to 100 μm.

5. The 3D-printer modeling material according to claim 1, wherein a content of the wire rod in the 3D-printer modeling material is in a range from 20 mass % to 70 mass %.

6. The 3D-printer modeling material according to claim 1, wherein a content of the resin in the 3D-printer modeling material is in a range from 30 mass % to 80 mass %.

7. The 3D-printer modeling material according to claim 1, wherein the wire rod is twisted.

8. The 3D-printer modeling material according to claim 1, wherein at least a part of an outer circumferential surface of the wire rod is coated with the resin.

9. The 3D-printer modeling material according to claim 1, wherein
the resin is a yarn-shaped resin, and
the yarn-shaped resin is unidirectionally or multi-directionally and helically wound around an outer circumferential surface of the wire rod.

10. The 3D-printer modeling material according to claim 1, wherein the wire rod further comprises a yarn-shaped carbon fiber.

11. The 3D-printer modeling material according to claim 1, wherein a tensile strength of the wire rod is 100 MPa or more.

12. The 3D-printer modeling material according to claim 1, wherein the 3D-printer modeling material is a 3D-printer modeling material of a 3D printer configured to print by fused deposition modeling.

13. The 3D-printer modeling material according to claim 1, wherein
the thermoplastic resin is at least one resin selected from the group consisting of a polyolefin resin, polylactic resin, polyester resin, polyvinyl alcohol resin, polyamide resin, acrylonitrile-butadiene-styrene resin, acrylonitrile-styrene resin, acrylate-styrene-acrylonitrile resin, polycarbonate resin, and polyacetal resin.

14. A modeled object produced using the 3D-printer modeling material according to claim 1.
